(19) United States
(12) Patent Application Publication
(10) Pub. No.: US 2004/0066456 A1
(43) Pub. Date: Apr. 8, 2004

(54) Visual imaging network systems and methods

(76) Inventor: David Read, Austin, TX (US)

Correspondence Address: H. Dale Langley, Jr., Law Firm of H. Dale Langley, Jr. PC, 610 West Lynn, Austin, TX, 78703, US

(21) Appl. No.: 10/464,416

(22) Filed: Jun. 18, 2003

Related U.S. Application Data
(60) Provisional application No. 60/390,311, filed on Jun. 21, 2002.

(51) Int. Cl. H04N 9/74

(52) U.S. Cl. 348/207.1; 348/591

(57) ABSTRACT

A secure image communications system includes one or more cameras disposed at a first location, such as a day care center. The system also includes a computer disposed at the first location and connected to the camera or cameras, as the case may be. A server of the system is located at a second location, remote from the first location, but communicatively connected to the computer. The system also includes one or more display devices, which are disparately located remotely from the first location and the second location. Each display device is communicatively connected to the server, for example, via the Internet or other network. The cameras periodically, or virtually continuously, capture images from the first location. The images are saved and manipulated by the computer, for digitization and security. Digital data representative of each image is communicated to the server, via secure channels and schemes. The server enables authorized ones of the display devices to access the digital data, by client-server communications over the Internet or other network between the display device and the server. The display device displays the image rendered from the digital data, in substantially real time.

### BACKGROUND OF THE INVENTION

The present invention generally relates to cameras and network communications of visual images and, more particularly, relates to real-time visual imaging and network communications and remote viewing of the real-time images, such as remote viewing by parents of their children in day care via the Internet and secure video communications.

Media distribution over networks, for example, the Internet, continues to progress in design and complexity. As with many types of network communications generally, media communications over networks are plagued with issues of security and bandwidth constraints. Improved security and architectures are required in order to enable widespread media communications, such as camera images communicated for viewing at remote locations.

Parents of children in day care can have concerns about the treatment given the children, the activities of the children, and the general well-being of the children. Cameras and networked communications could permit parents to view the children via networked computers and other devices, from remote locations from the children. For example, parents at work could view their children as imaged by cameras at the day care center, if the camera images could be communicated over the Internet to computers accessible to the parents.

In such an imaging network system security and restriction of unauthorized viewing of images is quite important. Moreover, sufficient bandwidth and architectures are required to permit capture, communications, and display of the images. Substantially real-time implementations and operations in such systems is desirable.

The present invention provides novel and improved systems and methods for remote image viewing via communications networks, such as the Internet. The present invention also overcomes disadvantages of prior technology, and provides new and improved architectures and security concepts and designs, and is a significant improvement and advance in the art and technology.

### BRIEF DESCRIPTION OF THE DRAWINGS

The present invention is illustrated by way of example and not limitation in the accompanying figures, in which like references indicate similar elements, and in which:

FIG. 1 illustrates a secure visual image communications system including pluralities of cameras, a computer at or associated with the cameras at a location, a server, and end user devices for viewing select and particular images from one or more of the cameras, according to embodiments of the present invention;

FIG. 2 illustrates a method of operation of the computer of the system of FIG. 1, wherein the computer is located at or associated with the cameras at the location, and the computer communicates the camera images to a server of the system in secured manner, according to embodiments of the present invention;

FIG. 3 illustrates a method of operation of the server of the system of FIG. 1, wherein the server communicates over a network with the computer, to receive the images captured by the cameras, according to embodiments of the present invention;

FIG. 4 illustrates a method of operation of an end user device of the system of FIG. 1, which end user device performs an authorization procedure in order to communicate with the server to receive images, and then displays images at the end user device for visualization by a user of the device, according to embodiments of the present invention;

FIG. 5 illustrates a method of operation of the server of the system of FIG. 1, wherein the server also communicates over the network to serve up the images to select end user devices appropriate to view the images, according to embodiments of the present invention; and

FIG. 6 illustrates a secure image communication network according to the embodiments of FIG. 1, the network including scalability because of modularization of operations according to such embodiments, wherein the server includes pluralities of crypto servers and web servers for scalability and the cache server manages the pluralities and respective image data corresponding thereto, according to embodiments of the present invention.

### DETAILED DESCRIPTION

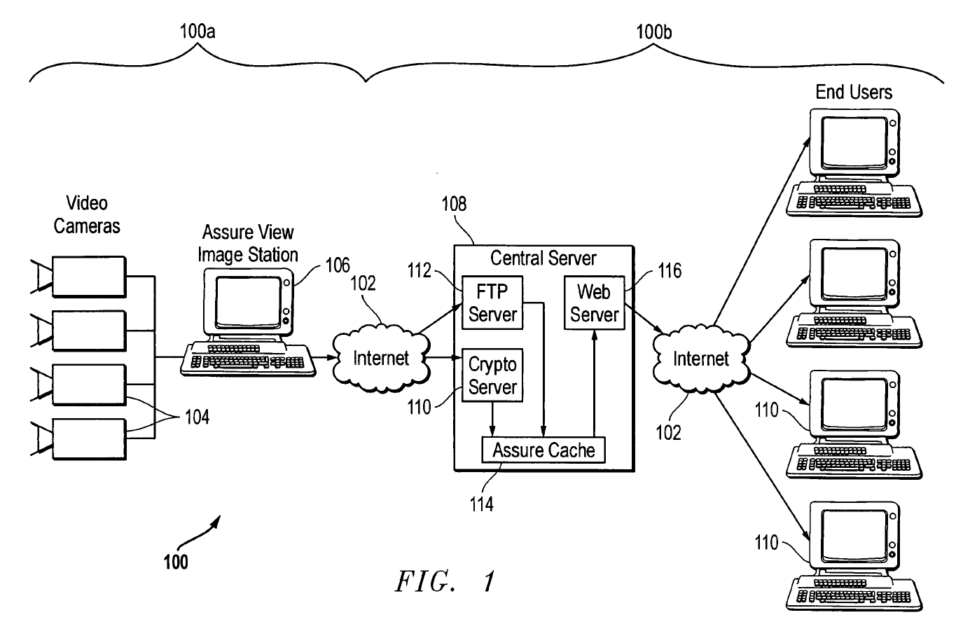

Referring to FIG. 1, a visual image network system 100 includes a communications network, such as the Internet 102. The system 100 has an image capture system 100a and an image distribution system 100b. The image capture system 100a obtains, saves, maintains, and prepares for communications various images, such as video or still images. The image distribution system 100b receives the various images communicated from the image capture system 100a, and saves, maintains, prepares for communications, serves, and displays the images on respective devices at locations which can be remote from the image capture system 100a.

The image capture system 100a of the system 100 includes one or more camera 104. The camera 104 can be any type or combination of types of camera or cameras. The camera 104 can, for example, be any digital still camera, video camera, or any other imaging device. The camera 104 provides a digital or digitally renderable image. If the camera 104 provides a digitally renderable image, but not a digital image, then additional elements (not shown in FIG. 1) are required to convert the image into digital format. In every event, the camera 104 includes appropriate electrical, optical, radio frequency, or other communications connector or connectors for connection to other elements of the image capture system 100a.

In a setup of the image capture system 100a for a day care center or the like, a plurality of cameras 104, either the same, different or other combinations of video imaging devices, are particularly located to focus on and render desired visual images. The cameras 104 can be distributed throughout a room or multiple rooms, for example. Moreover, the cameras 104 can be located inside facilities or outside facilities, such as at a playground or other outside area. Although four cameras 104 are shown in the illustration in FIG. 1, any single or plurality of cameras or other image capture devices are employable with and in the system 100, in accordance herewith.

In certain embodiments, the cameras 104 are standard analog video image capture devices. Multiple ones of the cameras 104 each connect to a capture board (not shown in detail) and include an appropriate driver for the board. The cameras 104 communicatively connect to the capture board, for example, via coaxial cables connected to and between each respective camera and the board. In such configuration, a useable capture board is the Picolo Pro 2, of Euresys. Such board includes four channels and enables 30 frames/sec capture when connected to one camera. Of course, all other suitable board capture devices and other elements are possible.

The cameras 104, either directly or through a capture board, as applicable, communicatively connect to a processing device, such as a personal computer 106. The personal computer 106 is physically located at or near the cameras 104 as installed in a facility or otherwise disposed for image capture operations. Alternatively, the personal computer 106 can be remotely located from the location at or near the cameras 104, however, additional networking and appropriate wiring or other connectors are necessary to permit ready communications between the cameras 104 and the personal computer 106. The personal computer 106 is any computing device sufficient for imaging operations, and includes a processor, memory, storage, input/output ports and connections, and other features necessary for the operations of receiving, manipulating, saving, maintaining, and/or communicating images and other signals.

The personal computer 106, or other similar device, as applicable, is communicatively connected to the Internet 102 or other communications network. The personal computer 106 communicates image data and other signals to and from the Internet 102 or other network, using conventional network protocols, such as Transport Control Protocol/Internet Protocol (TCP/IP). The communicative connection of the personal computer 106 to the Internet 102 can be a broadband connection, so that sufficient bandwidth is available for communications to and from the personal computer 106 with the Internet 102 for communicating large files of image data and other information in substantially real-time.

Continuing to refer to FIG. 1, the image distribution system 100b also communicatively connects to the Internet 102 or other network connected to the personal computer 106. The image distribution system 100b includes a server computer 108 that is communicatively connected to the Internet 102 or other network. The connection of the server computer 108 with and to the Internet 102 is also a broadband connection. The broadband connection provides sufficient bandwidth for ready communications of the image data and other files and signals, over the Internet 102, with and between the image capture system 100a and also with other features of the image distribution system 100b as hereinafter further described.

The server computer 108 includes a processor, input/output ports and interfaces to the Internet 102 or other network, storage, memory, and other internals and peripherals. The server computer 108 is any of a wide variety of servers or other storage and processing devices, having server functionality in a client-server relationship with the personal computer 106 via communicative interconnection to the Internet 102. The server computer 108 also communicatively connects to one or more end users 110, also via connection of the server computer 108 to the Internet 102.

The server computer 108 additionally includes a file transfer protocol (FTP) server 112. The FTP server 112 communicatively connects to the Internet 102 and the personal computer 106. The server computer 108 moreover includes a crypto server 110, an assure cache 114, and a web server 116. The crypto server 110 communicatively connects to the Internet 102 and the personal computer 106. The assure cache 114 connects to each of the crypto server 110 and the FTP server 112 of the server computer 108. The assure cache also connects to the web server 116 of the server computer 108. The web server 116 communicatively connects to the Internet 102, and thereby communicatively connects to one or more end user devices 110. The end user devices 110 are, for example, any of a variety of communication, processing, and display elements, such as computers, personal digital assistants, processor-enabled cellular telephones, laptops, and other fixed or mobile devices.

The server computer 108 communicates over the Internet 102 or other network to receive image data and other signals, using conventional network protocols, such as Transport Control Protocol/Internet Protocol (TCP/IP). The communicative connection of the server computer 108 to the Internet 102 is a broadband connection, providing sufficient bandwidth for communications to and from the personal computer 106 and also to and from the end user devices 110. In every event, the bandwidth of the connection of the server computer 108 to the Internet 102 or other network is sufficiently fast and robust for communicating large files of image data and other information in substantially real-time.

The FTP server 112 of the server computer 108 communicatively connects to the Internet 102 in order to permit FTP delivery of image data and other signals from the video cameras 104, via the personal computer 106 and the Internet 102, to the server computer 108. The crypto server 110 of the server computer 108 also communicatively connects to the Internet 102 in order to receive encrypted image data and other signals from the video cameras 104, by transfer via the personal computer 106 and the Internet 102. The assure cache 114 of the server computer 108 receives and maintains, by storage and otherwise, the image data and other signals received at the server computer 108.

Image data at the server computer 108 is selectively retrievable by the end user devices 110 over the Internet 102, through operations of the web server 116 of the server computer 108. The web server 116, for example, provides log-in/password security functions, limits accessibility to authorized and appropriate ones of the end user devices 110, and otherwise manages distributions of the image data to appropriate ones of the end user devices 110. In effect, the end user devices 110 are each capable of accessing select ones of the image data captured by the video cameras 104. The personal computer 106 and the server computer 108 operate, in conjunction, to provide security and restricted accessibility to image data from the various video cameras 104, as appropriate for the particular ones of the end user devices 110, as the case may be.

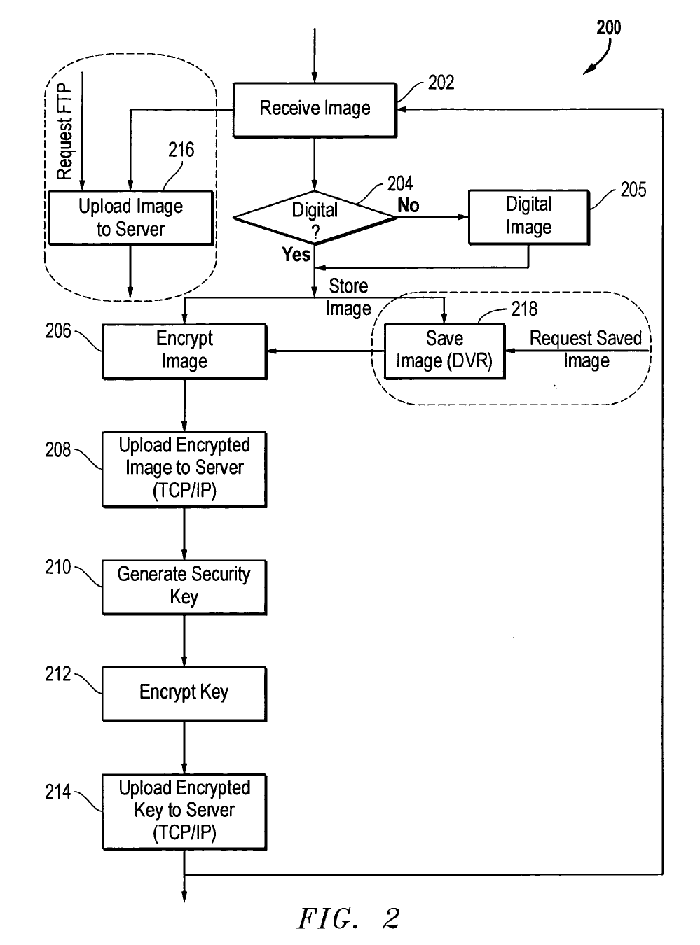

Referring to FIG. 2, a method 200 is performed by the personal computer 106 of FIG. 1. As the cameras 104 capture images at instants in time, the images are communicated to the capture board connected to the personal computer 106. The images are captured at distinct time periods, as set for the particular implementation, generally on the order of about one image per second per camera 104. Any other appropriate capture rate can be implemented in the method 200, in accordance with the capabilities and limitations of the cameras 104, the capture board, and the personal computer 106, as those skilled in the art will know and appreciate.

The personal computer 106 receives image data for each captured image in a step 202. In a step 204, the personal computer 106 determines whether or not to digitize the captured image received in the step 202. If the image is digital data, then the method 200 proceeds to a step 210 of generating a symmetric encryption key (or, alternatively or additionally, a step 218 of saving the images, as further described below). If the image data received by the personal computer in the step 202 is not digital data or otherwise appropriately formatted data, then the image is digitized or otherwise manipulated for appropriate formatting in a step 205 performed by the personal computer 106. After the step 205, if applicable, the symmetric encryption key is generated in the step 210. Whether or not the method 200 includes the step 205 in any particular application, the image data captured in the step 202 can be manipulated by compression or other techniques, as desired. In certain embodiments, for example, the image data is formatted and compressed as JPEG image data (or other compression format), prior to further operations of the method 200.

The personal computer 106 generates a distinct and different symmetric encryption key in the step 210 for each individual image uploaded to the server 108. The security key from the step 210 is itself encrypted in a step 212 of encrypting the symmetric key with the server's public key. The encryption performed in the step 212 for each security key can be RSA (RSA Data Security, Inc.) encryption (2048-bit) or other public key encryption. The public-encryption key for the RSA algorithm is maintained (such as via programming by an administrator) at the server 108.

In a step 206, the image is encrypted employing the symmetric key. The encryption employed in the step 206 can be any of a wide variety of available cryptographic schemes, for example, Advanced Encryption Standard (AES) encryption (256-bit, according to Rijndael), DES encryption, or other public domain or proprietary encryption is employed.

In a step 214, the RSA-encrypted key (i.e., the AES-encrypted key which is distinctly generated for each individual image of the step 206) is uploaded by the personal computer 106 to the server 108, over the Internet 102 or other network. The encrypted image data from the step 206 is thereafter uploaded in step 208, by the personal computer 106 over the Internet 102 (or other applicable network) to the server 108.

The method 200 thereafter returns to the step 202 of receiving a next image from the cameras 104. Encryption of image data for communication by the personal computer 106 over the Internet 102 to the server 108 may not be required in certain applications. For example, any image capture of public places, such as restaurants, bars, secured premises, and so forth, may not present security concerns. Moreover, analog cameras 104 and analog, rather than digital, image data may be desired or critical in certain applications. In such applications, it may be appropriate that the analog image data be communicated by the personal computer 106 over the Internet 102 to the server 108. In each of these types of applications, the image data is downloadable by the server 108, from the personal computer 106 via the Internet 102 or other network, by file transfer protocols (FTP), rather than the usual TCP/IP protocols employed in secured and generally appropriate communications by the personal computer 106 to the server 108 over the Internet 102 or other network. In operations of the server 108 for FTP transfers of image data, the server 108, via the FTP server 112 (shown in FIG. 1), requests the image data from the personal computer 106, and the personal computer 106 merely permits the server 108 to download the image file.

Additionally or alternatively, depending on the application and desired configuration and operations of the personal computer 106 and the method 200, image data can be saved on or at the personal computer 106. In the method 200, a step 218 indicates the save operation performed by the personal computer 106. The step 218 indicated in FIG. 2 can be performed after or even before any digitization 204, 205 or other data manipulation and formatting steps, as desired in the particular instance. The step 218 includes saving and storing individual or streamed image data captured by the cameras 104 and provided to the personal computer 106, for example, by means of a digital video recording (DVR), a tape-based storage system, other memory storage, and/or other saving and recording devices and steps. In such instances in which image data is saved and stored at or in connection with the personal computer 106, the personal computer 106 is equipped with appropriate hardware and software, including peripherals and the like, for the save operations. Any such saved image information at the personal computer 106 can be retrieved by FTP direct to the personal computer 106 or via the server 108, or any other conventional data retrieval steps or operations.

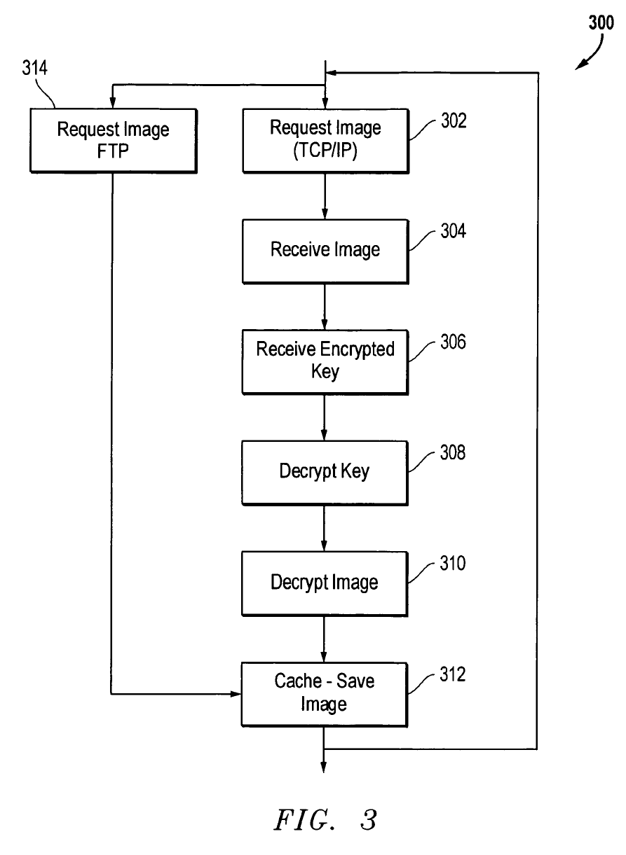

Referring to FIG. 3, a method 300 is performed by the server 108 of the system 100 of FIG. 1. In the method 300, encrypted image data is communicated by the personal computer 106 to the crypto server 110 of the server 108, in a step 304. The encrypted image data in the step 304 is communicated by upload by the personal computer 106 to the server 108, over the Internet 102 or other network. Thereafter, in a step 306, the personal computer 106 communicates over the Internet 102, and the server 108 receives, the encryption symmetric key applicable to the particular image data just received by the server 108 in the step 304. As previously mentioned, a separate and distinct encryption key, corresponding to each independent set of image data received by the server 108, is generated and sent by the personal computer 106 to the server 108. The server 108 receives each such key in the step 306.

The server 108 manipulates the key as received in the step 306, by decrypting the symmetric key in a step 308. The decrypted key from the step 308 is employed, in a step 310, to decrypt the image data at and within the server 108, using the decrypted symmetric key. The decrypted, digital image data is saved by the server 108 in a step 312. In the step 312, the image data is save in a cache storage of the server 108. Each successive image data received by the server 108, then, replaces the previously cache-saved image at the server 108. In this manner, the cache at the server 108 always holds and maintains a most recently received image from each of the cameras 104, as delivered to the server 108 over the Internet 102 or other network via the personal computer 106. After each next image is cache-saved at the server 108, and after any applicable delay period according to programming implementation at the server 108 (not shown in detail in FIG. 3), the method 300 returns to the step 302 of requesting.

In addition to the foregoing usual secured image operations of the server 108 in the method 300, the method 300 also includes a step 314 for performing FTP requests for image retrieval (or other similar implementations and protocols for download or other request and receipt of image data) by the server 108. It is notable that, as with the usual secured image operations, any image information received by the server 108 in the step 314 is also cache-saved in the step 312 by the server 108. This ensures that the image data maintained in cache storage at the server 108 is, at each and every instance, a most recent capture having been received by the server 108.

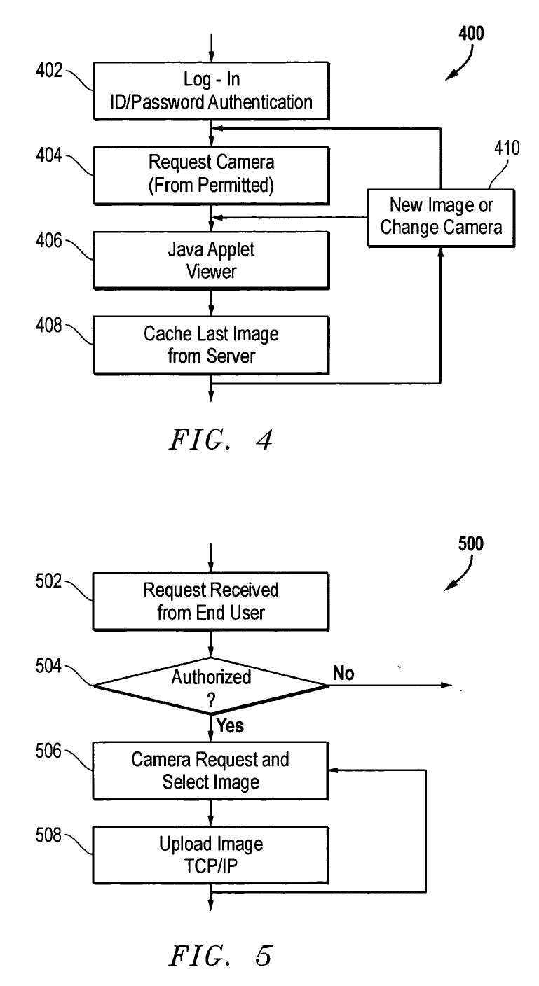

Referring to FIG. 4, each end user device 110 of FIG. 1 performs a method 400 to receive and display images captured and received at the server 108. In the method 400, the end user device 110 initially performs a log-in communication with the server 108 in a step 402. The log-in communication can be any typical arrangement providing authorization and security for end user devices 110 and preventing unauthorized and inappropriate access by all others. The end user device 110 communicates over the Internet 102 or other network, to the server 108 in the step 402. The end user device 110 receives from the server 108 any appropriate user-ID/password entry requirements. A user of the end user device 110 can then enter at the end user device 110, and transmit over the Internet 102 to the server 108, the various required input to authorize and pass security for access to the server 108 and the image data.

Once the end user device 110 is permitted access on the server 108 to obtain image data, a camera request is delivered by the end user device 110 to the server 108 in a step 404. In accordance with typical server and database operation of servers, the server 108 can limit the availability of certain cameras and images to each separate one of the end user devices 110 of the system 100 of FIG. 1. For example, any single end user device 110 may be permitted to access image data captured by cameras 104 located at XYZ Day Care, but be restricted from access to image data captured by cameras 104 at 123 Day Care. Of course, any limits or restrictions of access to information at the server 108 by respective ones of the end user device 108 will depend and be effected according to the particular application and administration of the system 100. In any event, the server 108 operations permitting access, on the one hand, and limiting or restricting access, on the other hand, are common database and communications operations that those skilled in the art will know and appreciate for operations like those of the server 108.

If an appropriate request is made by the end user device 110 in the step 404, the end user device 110 initially receives a java applet from the server 108 via the Internet 102. The java applet is received from the server 108 and is initialized and run on the end user device 110 in a step 406. The java applet, as run on the end user device 110, displays an image at the end user device 110 in a step 408, such as on a monitor or display, corresponding to the most recent image data received by the server 108 in respect of the particular camera 110 of the request of the step 404. As previously described, each next image data received by the server 108 in respect of each camera 110 replaces the then-cached image data at the server 108. Thus, the cached image data at the server 108 at any instant is the most recently received image information at the server 108. As a consequence, each image displayed at the end user device 110 via the java applet corresponds to the then-cached image data at the server 108, i.e., the most recently received image information at the server 108.

The method 400 returns to initiate a new camera request or to display a new image from data received at the server 108, via a step 410. The step 410 can be manually initiated at the end user device 110, for example, by a user's input at the device 110 that is subsequently communicated to the server 108 via the Internet 102. Additionally or alternatively, the step 410 can include automatic timing delay for refreshing of the image displayed at the end user device 110 after a programmed time segment, various selective or random viewing of multiples of cameras or images to which access is permitted for the particular end use device 110, or any of numerous other options, possibilities and features.

Referring to FIG. 5, a method 500 is performed by the server 108 in communicating with and serving up images to the end user devices 110 of FIG. 1, and each one of them. In the method 500, the server 108 receives a request in a step 502 from any of multiple end use devices 110. As described above with respect to FIG. 4 and the method 400 for operations of the end user devices 110, the end user device 110 initiates the request in steps 402 and 404 of FIG. 4. The server 108 performs the step 502, and then makes a determination in a step 504, such as a table or database lookup, to ascertain the request received in the step 502 involves an authorized and security-cleared end user device 110. If so, then the method proceeds to a step 506; otherwise, the method 500 concludes.

In the step 506, the server 108 receives a camera/image request from the end user device 110 over the Internet 102. The server 108 logically decides whether or not the particular end user device 110 should receive image data then maintained in the cache of the server 108, corresponding to the camera/image request. In a step 508, the server 108 communicates over the Internet 102, to the particular end user device 110, the image data then maintained in cache by the server 108. The method 500 thereafter continues by returning to the step 506 when the particular end user device 110 makes a next request either for a new image, a different camera and image, or otherwise.

In operation, the system 100 of FIG. 1, in accordance with the methods 200, 300, 400, and 500 of FIGS. 1-5, respectively, makes available for viewing on the end user devices 110, current (approximating real time) images from select ones of the cameras 104. The cameras 110 continuously capture images according to the location thereof Data indicative of the captured images, either digital or analog information, as the case may be depending on the characteristics of the cameras 110, is communicated to the personal computer 106. If the image information is analog signals from the cameras 110, or any of them, the personal computer 106 includes hardware and software that converts the signals to digital data files of the images. The digital data files, whether created at the personal computer 106 or received by the personal computer 106 from the cameras 110 (or any of them) in digital data forms, are manipulated and processed by the personal computer 106, for example, the data files are compressed as JPEG image files, or otherwise.

The compressed image data is communicated over the Internet 102 or other network to the server 108, by the personal computer 106. The server 108 receives the image data from the Internet 102 or other network, and the image data is saved in cache of the server 108. As has been previously discussed, the image data saved in cache of the server 108 at any instant is the most recently received image data from the personal computer 106 and cameras 110.

The server 108 can also or alternatively download image information from the personal computer 106 in other maimers, such as via FTP between the personal computer 106 and the FTP server 112 of the server 108. In any event, the image information is communicated between the personal computer 106 and the server 108 via the Internet 102 or other interconnecting communications network.

Compressed image data received by the server 108 from the personal computer 106 is received first at the crypto server 110 of the server 108. As was earlier described, communications between the personal computer 106 and the server 108 are typically encrypted or otherwise secure (with exception for the FTP features). Encryption keys and the like are individually generated for each separate image, and the keys are themselves encrypted and sent by the personal computer 106 to the server 108. The server 108, for example, by employing a public key scheme, decrypts the encrypted keys, and also thereby decrypts the image data.

The decrypted image data is maintained in cache memory 114 of the server 108, until a request for the data is made by an end user device 110 and communicated over the Internet 102 or other network to the server 108. The web server 116 of the server 108 communicates with the end user devices 110 to receive requests and serve up to the respective devices 110 appropriate image data corresponding to the requests. As has been explained, the server 108 and the end user devices 110 perform typical log-in and other authentication and security procedures. Moreover, once all authorized end user device 110 has made an appropriate request to the server 108 for an available and appropriate image, the server 108 (via the web server 116) communicates the image data to the end user device 110 over the Internet 102 or other network.

Any of a wide variety of conventional or proprietary or other security schemes and mechanisms can be employed to secure the image data transmitted by the server 108 to the proper end user device 110. In certain embodiments, for example, secure socket layer (SSL) links (i.e., secure hyper text transfer protocol (https://)) or other security can employed or implemented for securing communications between the server 108 and the respective end user device 110. Alternatively, other security or even no security can be employed and implemented as desired for the particular application.

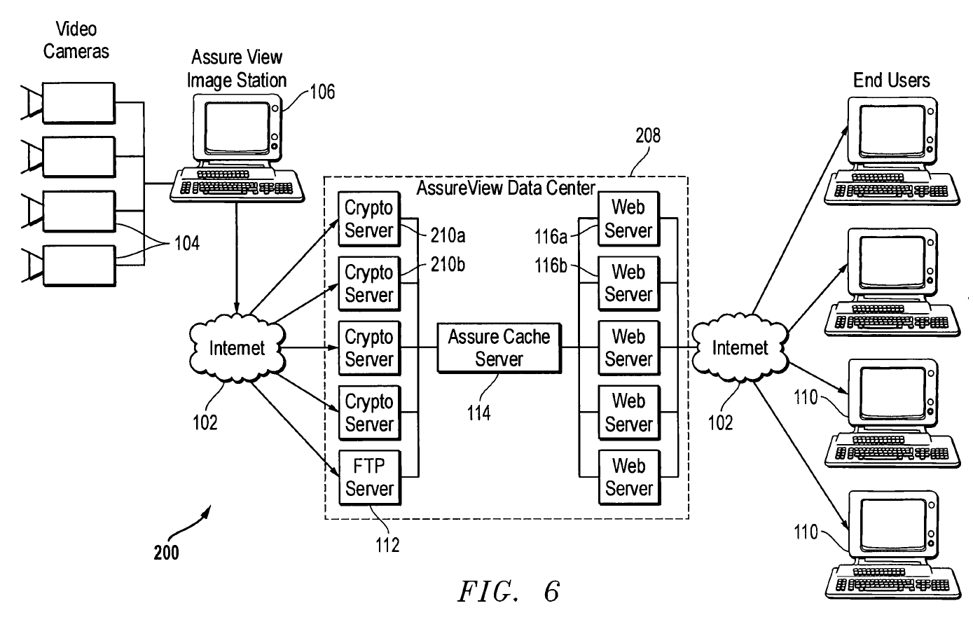

Referring to FIG. 6, a scalable system 600, according to similar concepts and embodiments as previously described, includes multiple ones of the server 108 of FIG. 1, for example, a server farm or bank or other configuration of servers permits pluralities of concurrent image capture and viewing. In the embodiment of FIG. 6, the system 600 includes the cameras 104, the personal computer 106, the end user cameras 110, and the Internet 102 or other network interconnecting the elements. The system 600 also includes the server bank 608, which is a plurality of server computers or server functions that serve the purpose of the server 108 of FIG. 1 but that permit scalability for multiples and pluralities of cameras 104 and personal computer 106 at various locations and also of end user devices 110 for accessing select ones of the images from the cameras 104 and personal computer 106 set-up at the locations.

In the scalable system 600, the server bank 608 is connected to the Internet 102 for communications thereon with the personal computer 106, and pluralities of personal computers as the case may be. The server bank 608 is also connected to the Internet 102 for communications with the end user devices 110, and pluralities thereof. The server bank 608 includes an FTP server 112, or more than one of them, for FTP transfer communications and operations over the Internet 102 or other network, between any of the personal computer 106 or plurality of them, and the server bank 608.

The server bank 608 also includes multiple, separate crypto servers 610a,b. Each crypto server 610a or b, and so forth, corresponds to and operates in communications over the Internet 102 with, one of the plurality of personal computers 106. In this manner, the security and other aspects of communications and operations of the server bank 608 in receiving and caching image data from cameras 104 is substantially modularized, so that each respective personal computer 106 (typically corresponding to a particular location and set of cameras 104) has a corresponding crypto server 610a of the server bank 608. In operation, each personal computer 106 operates and communicates over the Internet 102, with the respective crypto server 610a of the server bank 608, substantially as described in the foregoing description with respect to FIG. 1 for the case of a single personal computer 106 and single server 108.

In the server bank 608, an assure cache server 114 of the bank 608 connects to the each crypto server 610a,b and the FTP server 112, and also connects to respective ones of a plurality of web servers 116a,b. The web servers 116a,b each correspond to respective sets or pluralities of end user devices 110, permitting the sets or pluralities of the devices 110 to communicate over the Internet 102 with the server bank 608, via the respective web server 116a,b in order to receive appropriate image data. The assure cache server 114 administers and manages each image data received by the server bank 608 at any crypto server 610a,b or the FTP server 112. In such administration and management, the assure cache server 114 makes available to each web server 116a,b, as appropriate and required for communications with the end user devices 110, appropriate image data. The image data, and its availability to appropriate end user devices 110 via the respective and corresponding web server 116a,b, is controlled by the assure cache server 114. The assure cache server 114 has modular architecture, so that each image is handled via the corresponding crypto server 610a,b and the respective web server 116a,b, all in accord with the previously described schemes and system 100 of FIG. 1 and the methods of FIGS. 2-5.

As can be understood, the entire system 600 is quite scalable. As additional video cameras 104 are added at new locations, an additional personal computer 106 is added to the system 600 for the location and cameras 104. With addition of each personal computer 106, the server bank 608 is scaled by adding an additional crypto server 610a,b and an additional web server 116a,b. Each additional web server 116a,b enables access and viewing of appropriate image data by respective end user devices 110. In every event, the assure cache server 114 of the server bank 608 manages image data as received and distributed by the server bank 608, by assimilating each image data received with corresponding crypto server for receipt of the data at the server bank and with corresponding web server of the server bank for communication of the data to appropriate end user devices accessing the server bank via the particular web server.

In operation of the foregoing systems and methods, alternative business and technical arrangements are possible. For example, the network could be a wide area or distributed, public or private, network, an intranet, or even an intranet combination or intranet-extranet combination. Numerous client and server devices can be simultaneously intercommunicating. The network can include any number and type of communicative elements and interconnections. Moreover, banks of the server computers or even banks or pluralities of server banks can be possible for receiving communications from pluralities of computers servicing pluralities of camera devices, analog or digital or other. The cameras, computers, server computers, and end user devices, and any of them, can be centrally located or distributed through a wide geographic area, and any of them can also or alternatively be mobile, moveable or otherwise periodically or intermittently operations or locatable. In the case of a global network such as the Internet, the network is capable of generally communicating by its protocols, which may include specialized and other protocols for specific situations.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and any element(s) that may cause any benefit, advantage, or solution to occur or become more pronounced are not to be construed as a critical, required, or essential feature or element of any or all the claims. As used herein, the terms “comprises, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A secure image communications system, comprising:
at least one camera disposed at a first location;
a computer disposed at the first location, connected to the at least one camera;
a server disposed at a second location, communicatively connected to the computer; and
a display device disposed at a third location, communicatively connected to the server;
wherein communications of an image data by the computer to the server is secured and communications of the image data by the server to the display device is secured.

2. The system of claim 1, further comprising an image capture board disposed at the first location, connected to the at least one camera and the computer.

3. The system of claim 2, wherein the image data is digital.

4. The system of claim 2, wherein the camera communicates digital image data to the computer.

5. The system of claim 2, wherein the camera communicates an analog image signal to the computer, and the computer converts the analog image signal to digital image data.

6. The system of claim 2, wherein the computer comprises:
an encrypter for encrypting the image data; and
a key generator for generating a unique security key corresponding to the encryption of the image data, for each independent one of the image data.

7. The system of claim 6, wherein the computer further comprises:
a key encrypter for encrypting the unique security key.

8. The system of claim 7, wherein the key encrypter is a public key encryption scheme and the server maintains the public key for the scheme.

9. The system of claim 2, wherein the display device is mobile.

10. The system of claim 2, wherein the server comprises:
at least one crypto server;
a cache server; and
at least one web server.

11. The system of claim 10, wherein the server comprises:
a plurality of the crypto server; and
a plurality of the web server.

12. The system of claim 10, wherein the system comprises:
a plurality of the display device;
wherein each of the plurality of the display device is permitted by the server to receive and view only certain image data.

13. A method of secure communications of image data, comprising the steps of:
capturing an image at a first location;
digitizing the image at the first location, to obtain the image data;
encrypting the image data; and
transmitting the image data as encrypted to a second location.

14. The method of claim 13, further comprising the steps of:
generating a security key at the first location, the security key corresponding to the step of encrypting and capable of enabling decryption;
encrypting the security key via a public-key encryption schema; and
transmitting the security key as encrypted to the second location.

15. The method of claim 13, further comprising the steps of:
receiving the image data and the security key at the second location;
decrypting the security key via a public-key available at the second location; and
decrypting the image data.

16. The method of claim 15, further comprising the step of:
caching the image data at the second location.

17. The method of claim 16, further comprising the step of:
serving the image data from the second location to a display device at a third location.

18. The method of claim 17, further comprising the step of:
receiving the image data by the display device at the third location;
displaying an image corresponding to the image data by the display device; and
wherein the steps of serving and receiving are secure.

19. The method of claim 18, wherein the security of the steps of serving and receiving is enabled by secure socket layer (SSL).

20. A method of viewing an image of a day care center, from a location remote from the day care center, comprising the steps of:
capturing the image;
obtaining a digital data that represents the image;
communicating the digital data to a server;
transmitting the digital data by the server to the location remote from the day care center; and
rendering the image from the digital data, at the location remote from the day care center;
wherein the digital data is secured in the steps of communicating and transmitting.

21. A system for viewing an image of a day care center, from a location remote from the day care center, comprising:
a camera located at the center, for capturing the image;
a computer at the center, connected to the camera;
a server located remote from the center, connected to the computer; and
a display device located remote from the server and the center; connected to the server;
wherein communications between the computer and the server, and between the server and the display device, are secured; and
wherein the display device, if appropriately authorized via the server, receives and displays the image in substantially real time.
